(19) United States
(12) Patent Application Publication
(10) Pub. No.: US 2005/0039543 A1
(43) Pub. Date: Feb. 24, 2005

(54) Apparatus and method for determining the shearing strength of a thermal insulation

(76) Inventors: Lars Heselius, Pargas (FI); Jacob Fellman, Pargas (FI); Tarmo Willman, Kaarina (FI)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/495,154

(22) PCT Filed: Nov. 6, 2002
(86) PCT No.: PCT/FI02/00863

(30) Foreign Application Priority Data
Nov. 14, 2002 (FI) 20012213

(51) Int. Cl. G01N 3/24

(52) U.S. Cl. 73/841

(57) ABSTRACT

The invention relates to an apparatus and method for determining the shearing strength of a thermal insulation. The apparatus (1) comprises a mobile clamping element (2) and alongside the same at least one immobile clamping element (3), each provided with a cavity (2a, 3a) capable of receiving part of a strip-like test specimen (15) to be cut off a thermal insulation. The apparatus is adapted to apply a force F to the mobile clamping element for moving the mobile clamping element (2) relative to the immobile clamping element (3) for achieving the shearing of the presently measured strip (15) at a location (14) between the mobile clamping element (2) and the immobile clamping element (3). The apparatus is further provided with means (16) for measuring the force F for its magnitude. The method comprises cutting a thermal insulation for a strip-like test specimen (15), having certain dimensions in various directions, said strip being then placed in a measuring apparatus (1) for shearing strength. The apparatus is used for applying a force F to the mobile head for moving the mobile clamping element (2) relative to the immobile clamping element (3) for achieving the shearing of the presently measured strip (15) at a location (14) between the mobile clamping element (2) and the immobile clamping element (3), said force F being measured for its magnitude, and the shearing strength being determined on the basis thereof.

The present invention relates to an apparatus and method for determining the shearing strength of a thermal insulation, said thermal insulation being possibly manufactured e.g. from structural wool, or also from polyurethane foam or polystyrene foam. Structural wool, i.e. so-called hard wool, comprises a plurality of fiber layers of mineral wool, which make up a wool panel. Mineral wool panel can be used as such for a variety of thermal insulation applications, or it can be processed for a variety of sandwich structures, such as e.g. sandwich panels, comprising surface boards of e.g. plastic-coated sheet steel and a core layer of mineral wool therebetween. Said core layer can be made directly from a wool mat, the fibers lying in planes substantially parallel to the surface boards, or for example in such a way that a mat of mineral wool is cut for lengthwise lamellae, which are turned 90° about the longitudinal axis thereof in such a way that the fibers lie in a substantially perpendicular relationship to the surface boards of a sandwich panel. A number of lamellae are glued to each other laterally and successively for producing a wool core of a desired size, the width of a lamella cut from the wool mat defining the thickness of a core layer. Thus applied, a core section made from a wool panel functions as structural wool. In so-called lightweight sandwich elements, the core section can be made from e.g. polyurethane or polystyrene foams instead of structural wool. The inventive apparatus and method can also be used for testing a core section of such elements, as long as the core section is manufactured as a prefabricated unit which is then glued securely to the surface boards of a panel.

Structural wool is subject to several different strength requirements, one being its shearing strength. Thus far, shearing strength has been measured principally as defined in standard SFS-EN12090, which is nevertheless an inconvenient and slow process. The standardized method requires at least 30 minutes or more, as it involves waiting for the glue to dry. Hence, it is an object of the present invention to provide a novel method of determining the shearing strength of structural wool, an apparatus used therein being characterized in that the apparatus comprises a mobile clamping element and alongside the same at least one immobile clamping element, each provided with a cavity capable of receiving part of a strip-like test specimen to be cut off a thermal insulation, said apparatus being adapted to apply a force F to the mobile clamping element for moving the mobile clamping element relative to the immobile clamping element for achieving the shearing of the presently measured strip at a location between the mobile clamping element and the immobile clamping element, said apparatus being further provided with means for measuring the force F for its magnitude.

On the other hand, a method of the invention is characterized in that the method comprises cutting a thermal insulation for a strip-like test specimen, having certain dimensions in various directions, said strip being then placed in a measuring apparatus for shearing strength, said apparatus comprising a mobile clamping element and alongside the same at least one immobile clamping element, each provided with a cavity capable of receiving part of the strip-like test specimen, said apparatus being used for applying a force F to the mobile head for moving the mobile clamping element relative to the immobile clamping element for achieving the shearing of the presently measured strip at a location between the mobile clamping element and the immobile clamping element, said force F being measured for its magnitude, and the shearing strength being determined on the basis thereof.

An advantage offered by the inventive method of determining shearing strength is that a shearing strength test can be performed quickly, as it takes no more than 2-3 minutes and, thus, can be used for continuous production control.

A European product standard regarding sandwich structures is under development, the chosen test method being a so-called beam test. The beam test comprises cutting an element for a beam about 100-200 mm wide, having a length of about 1000-2000 mm. It is good for testing a finished product, but not for testing solely a core section and, moreover, it is tedious and hence inapplicable to direct production control.

The invention will now be described in more detail with reference to the accompanying drawings, in which:

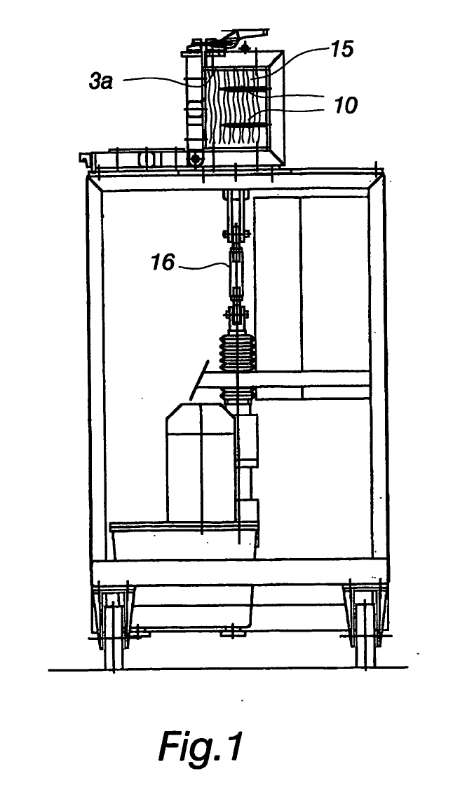

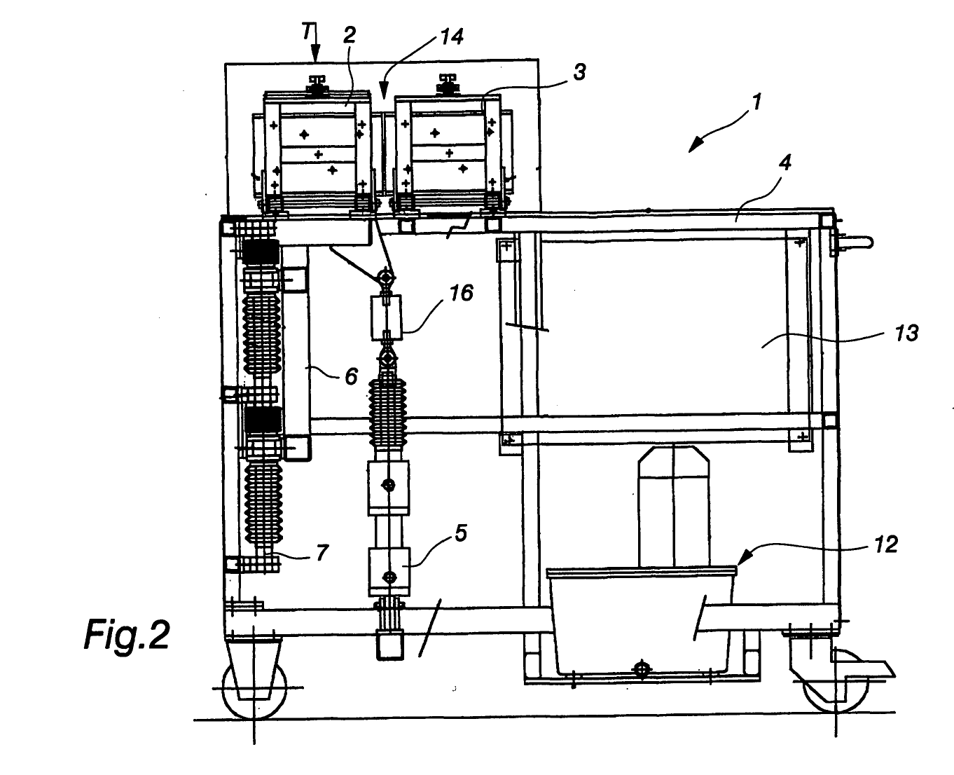

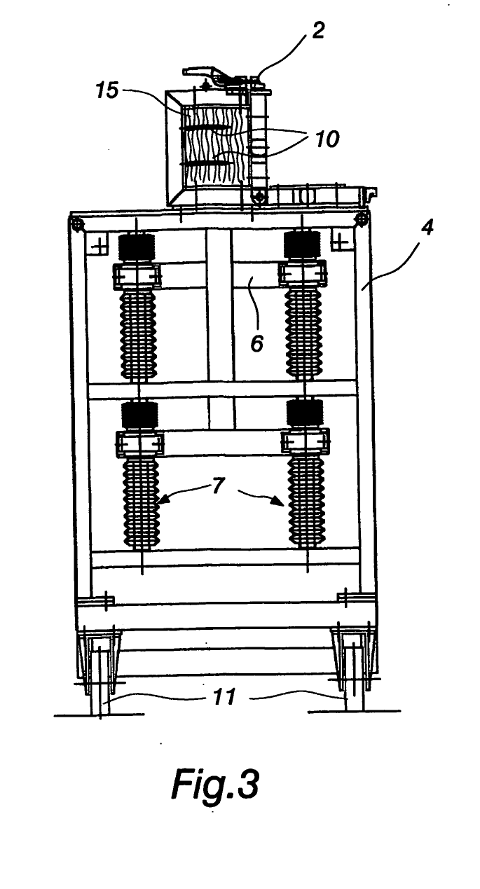

FIGS. 1-3 show one exemplary embodiment for an apparatus of the invention in schematic views from one end, from the front, and from the other end, respectively.

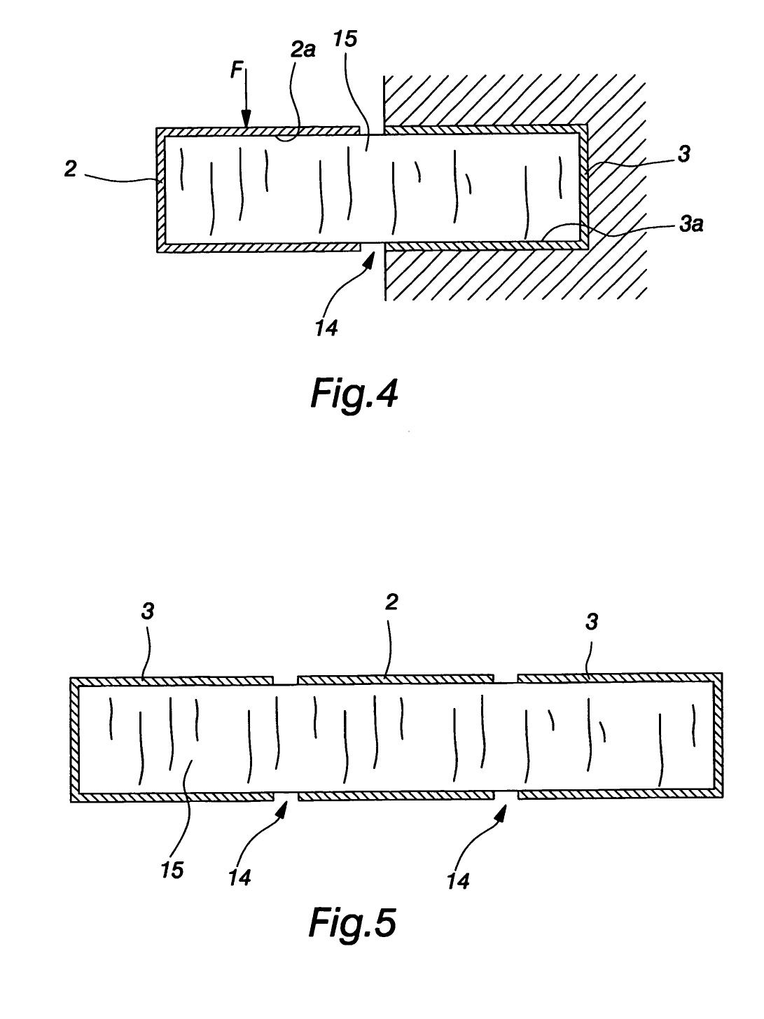

FIG. 4 shows schematically one inventive method of performing a shearing test for mineral wool.

FIG. 5 shows schematically another inventive method of performing a shearing test for mineral wool.

An apparatus 1 as shown in FIGS. 1-3 comprises a frame element 4 movable on wheels 11. On top of the frame element 4 are mounted a mobile clamping element 2 and an immobile clamping element 3, which are provided with cavities 2a and 3a, respectively, capable receiving a test specimen 15 cut off a mat of mineral wool. Immobility of the test specimen is secured by means of prongs 10 in the receiving cavity of each clamping element. The immobile clamping element 3 remains stationary on top of the frame element 4, while the mobile clamping element 2 is adapted to be movable by the action of a carriage 6 along linear guides 7 in a vertical plane. This vertical movement is accomplished by means of a hydraulic cylinder 5, which is connected to the mobile clamping element 2 by way of a power sensor 16. The apparatus 1 includes further a hydraulic unit 12 for producing necessary hydraulic energy, as well as a power distribution board 13.

In operation, the strip-like test specimen 15 cut off a mat of mineral wool is placed, as shown in FIG. 4, in the receiving cavity 2a and respectively 3a of the mobile element 2 and the immobile element 3, whereafter the mobile element 2 is subjected to an application force F by displacing the mobile element 2 at a constant traveling speed relative to the immobile element 3, whereby, as the force F increases to a sufficient magnitude, the strip 15 of mineral wool undergoes shearing at a location 14 between the mobile and immobile elements. The power sensor 16 can be used for measuring the value of force F at various times and for working out the shearing strength of a mat of mineral wool from the maximum value force. The number of test specimens made is preferably four, the average of shearing strength calculated from the breaking load thereof being applied as a shearing strength value for the presently examined mat of mineral wool. A test specimen is different from a final product as there are no surface boards, resulting in a certain distortion in the value of shearing strength as compared to a final product, but this is accommodated by using a suitable calibration factor determinable experimentally or mathematically.

FIG. 5 shows a method of the invention in another embodiment, comprising two immobile clamping elements 3, and therebetween a mobile clamping element 2 which is subjected to a force F for operating the same relative to the immobile elements. A test strip 15 is placed in the apparatus in such a way that it extends into the receiving cavities of all three clamping elements, the strip being shorn at two locations when operating the apparatus.

A major advantage gained by a method of the invention is the simplicity and speed of the method, which makes it possible to apply the method also for continuous production control. The method and apparatus are described above principally in reference to mineral wool, and particularly in reference to mineral wool used for the core section of sandwich elements, but it is also applicable to other thermal insulations, in which shearing strength is an important factor. In addition to the core section of sandwich elements, structural wool can also be used e.g. for external heat insulation by gluing wool lamellae directly to a wall surface and by topping the same with a plaster coating.

1-8. (canceled)

9. An apparatus for determining the shearing strength of a thermal insulation, the apparatus comprising:
a mobile clamping element and at least one immobile clamping element positioned alongside the mobile clamping element, wherein each of the clamping elements is formed with a cavity sized to receive a portion of a strip-like test specimen of the thermal insulation;
means for applying a force to the mobile clamping element thereby to move the mobile clamping element relative to the immobile clamping element and cause shearing of the strip-like test specimen at a location between the mobile clamping element and the immobile clamping element; and
means for measuring a magnitude of the force.

10. The apparatus of claim 9 comprising a single immobile clamping element and a single mobile clamping element.

11. The apparatus of claim 9, in which the at least one immobile clamping element comprises two immobile clamping elements and the mobile clamping element is positioned between the two immobile clamping elements.

12. The apparatus of claim 9, comprising means for operating the mobile clamping element at a constant speed, wherein a speed rate of the operating means is variable.

13. A method for determining the shearing strength of a thermal insulation, comprising:
cutting a thermal insulation to obtain a strip-like test specimen;
placing the strip-like test specimen in a shearing strength measuring apparatus, the shearing strength measuring apparatus including a mobile clamping element and at least one immobile clamping element positioned alongside the mobile clamping element, wherein each of the clamping elements is formed with a cavity sized to receive a portion of a strip-like test specimen of the thermal insulation;
applying a force with the shearing strength measuring apparatus to the mobile clamping element thereby to move the mobile clamping element relative to the immobile clamping element and cause shearing of the strip-like test specimen at a location between the mobile clamping element and the immobile clamping element;
measuring a magnitude of the force; and
determining the shearing strength based on the measured magnitude of the force.

14. The method of claim 13, in which the thermal insulation comprises a prefabricated core section of a sandwich building element, and in which the method is used to test the shear strength of the prefabricated core section of the sandwich building element.

15. The method of claim 14, in which the prefabricated core section comprises structural wool.

16. The method of claim 15, in which the strip-like test specimen is placed in the cavities of the clamping elements such that fibers of the test specimen are oriented substantially parallel to a direction along which the force is applied.
